(19) United States
(12) Patent Application Publication
(10) Pub. No.: US 2023/0194270 A1
(43) Pub. Date: Jun. 22, 2023

(54) MULTI-MODAL NAVIGATION SYSTEM

(71) Applicant: Rivian IP Holdings, LLC, Plymouth, MI (US)

(72) Inventors: Jason Quint, Ann Arbor, MI (US); Wei Koh, Mountain View, CA (US)

(21) Appl. No.: 17/557,380

(22) Filed: Dec. 21, 2021

(51) Int. Cl. G01C 21/34; G01C 21/36

(52) U.S. Cl. CPC G01C 21/3423; G01C 21/3676; G01C 21/3626

(57) ABSTRACT

A multi-modal navigation system for a vehicle is disclosed. The navigation system is configured to determine a multi-modal route including a driving route to a driving destination and a pedestrian route to a pedestrian destination from the driving destination. Turn-by-turn driving navigation for the driving route is provided, and data for the pedestrian route is provided to a mobile device such that turn-by-turn pedestrian navigation for the pedestrian route is enabled via the mobile device.

### INTRODUCTION

The present disclosure relates generally to the automotive and route planning fields. More particularly, the present disclosure relates to multi-modal turn-by-turn navigation handoff between a vehicle and a mobile device.

Vehicle route planning typically takes into account current location or trip origin, trip destination, trip mileage, among other information. For example, when a user at a current location enters a desired trip destination into his or her infotainment, navigation system, or mobile device, a vehicle route application may display an available route for the user to select, after which, the vehicle route application provides navigation to the desired trip destination.

The present introduction is provided as illustrative environmental context only and should not be construed as being limiting in any manner. It will be readily apparent to those of ordinary skill in the art that the concepts and principles of the present disclosure may be applied in other environmental contexts equally.

### SUMMARY

The present disclosure provides a multi-modal turn-by-turn navigation handoff between a vehicle and a mobile device. In particular, the present disclosure provides handoff of driving directions to an in-vehicle navigation system (such as a navigation application running on a controller within the vehicle) and handoff of pedestrian directions to a mobile device (such as a navigation application running on the mobile device). In this manner, a multi-modal trip that includes both a driving route and a pedestrian route (non-vehicular travel, such as walking, running, biking, scootering, etc.) can be planned on one device (either on the in-vehicle navigation system or the mobile device) with each leg of the multi-modal trip being provided on the relevant device (driving leg being provided on the in-vehicle navigation system and the pedestrian leg being provided on the mobile device).

In one illustrative embodiment, the present disclosure provides an in-vehicle navigation system for a vehicle. The in-vehicle navigation system includes one or more processors and a memory storing computer-executable instructions that, when executed, cause the one or more processors to receive a destination input for the vehicle; based on the destination input, determine a multi-modal route including a driving route to a driving destination from a current location of the vehicle and a pedestrian route to a pedestrian destination from the driving destination; provide turn-by-turn driving navigation instructions for the driving route; and provide data for the pedestrian route to a mobile device associated with the user, wherein the data enables turn-by-turn pedestrian navigation instructions for the pedestrian route via the mobile device

In another illustrative embodiment, the present disclosure provides a method for multi-modal navigation. The method includes receiving, at an in-vehicle navigation system of a vehicle, a destination input for the vehicle. The method also includes, based on the desired destination, determining, by an in-vehicle navigation system of a vehicle, a multi-modal route including a driving route to the driving destination from a current location of the vehicle and a pedestrian route to a pedestrian destination from the driving destination. The method further includes providing, by the in-vehicle navigation system, turn-by-turn driving navigation for the driving route. The method yet further includes providing data for the pedestrian route to a mobile device associated with the user. The data enables turn-by-turn pedestrian navigation for the pedestrian route via the mobile device.

In a further illustrative embodiment, the present disclosure provides a method for multi-modal navigation. The method includes obtaining a driving destination for an associated vehicle. The method also includes, based on the driving destination, determining a driving route to the driving destination from a location of the associated vehicle. The method further includes, based on the location of the associated vehicle and a current location of a mobile device associated with the user, determining a pedestrian route from the current location of the mobile device to the location of the associated vehicle. The method yet further includes providing turn-by-turn pedestrian navigation from the current location of the mobile device to the associated vehicle via the mobile device. The method still further includes providing data for the driving route to an in-vehicle navigation system of the associated vehicle. The data enables turn-by-turn driving navigation for the driving route via the in-vehicle navigation system.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic illustration of one illustrative embodiment of a vehicle route planning system of the present disclosure;

FIG. 2 is a schematic illustration of one illustrative embodiment of a User Interface (UI) for in-vehicle navigation of the present disclosure highlighting a driving route to a driving destination;

FIG. 3 is a schematic illustration of the UI of FIG. 2 highlighting nearby amenities to the driving destination;

FIG. 4 is a schematic illustration of the UI of FIGS. 2 and 3 highlighting a list of nearby amenities to the driving destination;

FIG. 5 is a schematic illustration of the UI of FIGS. 2-4 highlighting a pedestrian route between the driving destination and a selected amenity/pedestrian destination;

FIG. 6 is a schematic illustration of the UI of FIGS. 2-5 highlighting a notification that data for the pedestrian directions have been sent to the mobile device;

FIG. 7 is a schematic illustration of the illustrative embodiment of FIGS. 2-6 illustrating a lock screen of a mobile device of the present disclosure;

FIG. 8 is a schematic illustration of illustrative embodiment of FIGS. 2-7 illustrating a UI for navigation on a mobile device of the present disclosure highlighting the pedestrian destination/pedestrian directions received from the vehicle;

FIG. 9 is a schematic illustration of another illustrative embodiment of a UI for multi-modal navigation on a mobile device of the present disclosure highlighting a driving route to a driving destination;

FIG. 10 is a schematic illustration of the UI of FIG. 9 highlighting a pedestrian route to an associated vehicle;

FIG. 11 is a schematic illustration of the UI of FIGS. 9 and 10 highlighting a notification that the driving directions have been sent to the associated vehicle;

FIG. 12 is a schematic illustration of illustrative embodiment of FIGS. 9-11 illustrating a UI for in-vehicle navigation of the present disclosure highlighting a driving route to the driving destination received from the mobile device;

FIG. 13 is a flowchart of one illustrative embodiment of a method for multi-modal route planning of the present disclosure;

FIG. 14 is a flowchart of another illustrative embodiment of a method for multi-modal route planning of the present disclosure;

FIG. 15 is a network diagram of a cloud system for implementing the various systems and methods of the present disclosure;

FIG. 16 is a block diagram of a server/processing system that may be used in the cloud system of FIG. 15 or stand-alone; and

FIG. 17 is a block diagram of a computing device that may be used in the cloud system of FIG. 15 or stand-alone.

### DETAILED DESCRIPTION

Again, in various embodiments, the present disclosure relates to a multi-modal turn-by-turn navigation handoff of driving directions to an in-vehicle navigation system (such as a navigation application running on a controller within the vehicle) and of pedestrian directions to a mobile device (such as a navigation application running on the mobile device). In this manner, a multi-modal trip that includes both a driving route and a pedestrian route (non-vehicular travel, such as walking, running, biking, scootering, and the like) can be planned on one device (either on the in-vehicle navigation system or the mobile device) with each leg of the multi-modal trip being provided on the relevant device (driving leg being provided on the in-vehicle navigation system and the pedestrian leg being provided on the mobile device).

As will be described in further detail below, the route planning and handoff between devices/applications occurs in various manners. In one embodiment, a multi-modal route is planned on the in-vehicle navigation system that includes a driving route to a driving destination (such as a charging station or parking lot) and a pedestrian route (for walking, running, biking, scootering, and the like) from the driving destination to a pedestrian destination (such as an amenity nearby the driving destination/parking lot). The in-vehicle navigation system provides the turn-by-turn navigation therein and provides data to the mobile device for the turn-by-turn navigation between the driving destination and the pedestrian destination to be provided thereon. In another embodiment, the multi-modal route is planned on the mobile device and the mobile device provides data to the in-vehicle navigation system for the turn-by-turn driving navigation to the driving destination while providing the turn-by-turn pedestrian navigation to the pedestrian destination thereon. In a further embodiment, if an associated vehicle is not within range of the mobile device, while planning a driving route, a pedestrian route to the associated vehicle is provided and data for the driving route from the associated vehicle to the driving destination is provided to the in-vehicle navigation system for the turn-by-turn driving navigation to the driving destination.

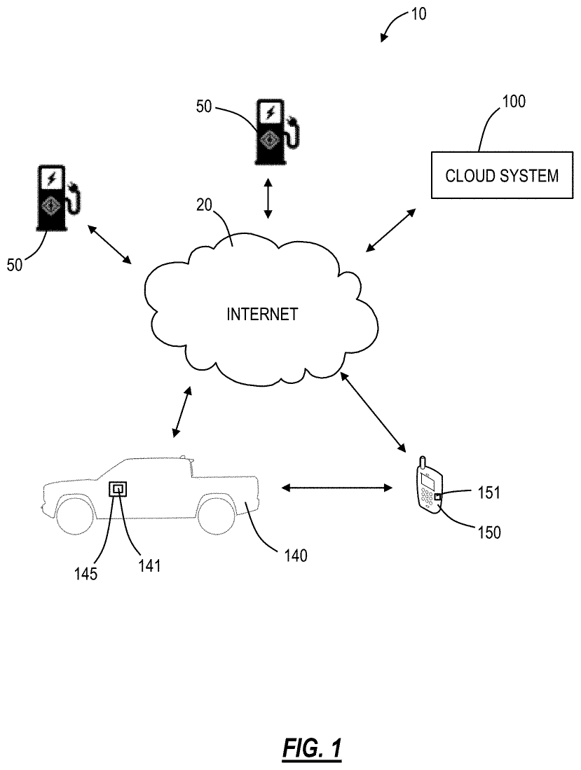

FIG. 1 is a schematic illustration of one illustrative embodiment of a vehicle route planning system 10 of the present disclosure. In various embodiments, the vehicle route planning system 10 includes at least a vehicle 140 and a mobile device 150. In particular, the vehicle route planning system 10 includes one or more applications 141 running on an in-vehicle navigation system 145 of the vehicle 140 and one or more applications 151 running on the mobile device 150. In some embodiments, the one or more applications 141 and the one or more applications 151 each include a navigation application that is configured to provide turn-by-turn navigation therein. In some embodiments, the one or more applications 151 also include a vehicle control application. In some of these embodiments, the vehicle control application is configured to relay information between the in-vehicle navigation system 145 and the navigation application on the mobile device 150. In some embodiments, the in-vehicle navigation system 145 is or is part of any control system, infotainment system, and the like of the vehicle 140; and the mobile device 150 is or is part of a cellular phone, a tablet, a laptop, and the like.

In embodiments, the vehicle route planning system 10 includes a cloud system 100. In these embodiments the cloud system 100 is configured to perform one or more of passing/pushing data between the in-vehicle navigation system 145 and the mobile device 150, providing data for navigation to the in-vehicle navigation system 145 and the mobile device 150, determining routes for the navigation on the in-vehicle navigation system 145 and the mobile device 150, identifying which charging station 50 should be used to charge the battery of the vehicle 140, and the like. The charging stations 50 are adapted for charging the battery, such as an arrangement of battery cells, of the vehicle 140.

As illustrated in FIG. 1, communication between the in-vehicle navigation system 145 and the mobile device 150 can occur directly, such as via short-range radio communication (e.g. Bluetooth™) or other wireless network protocols (e.g. Wi-Fi), and indirectly, such as via the cloud system 100 over the internet 20.

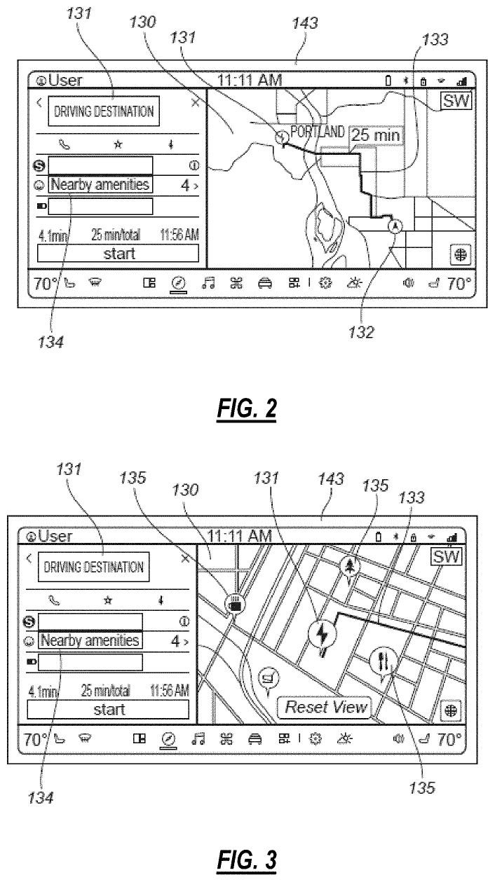

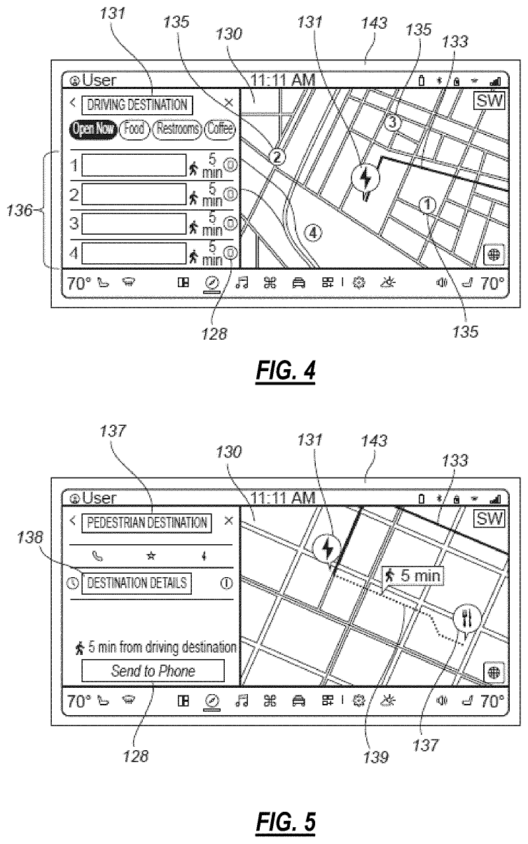

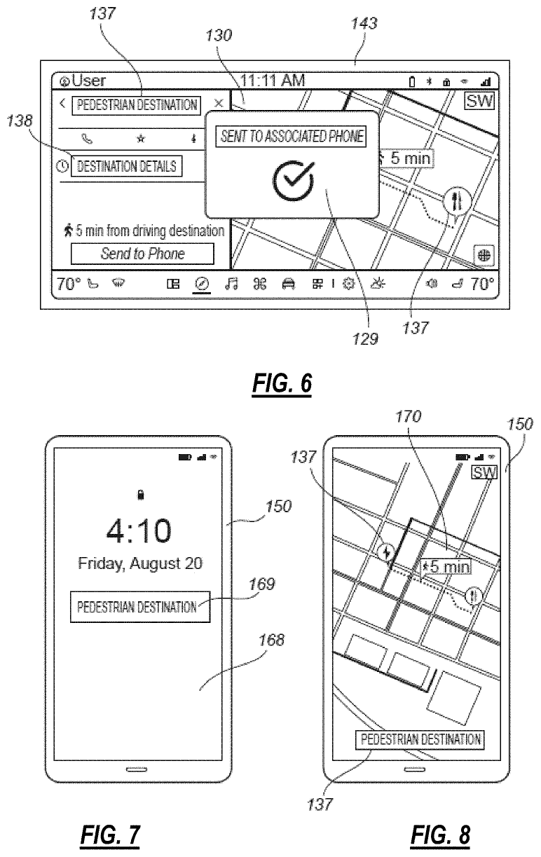

FIG. 2 is a schematic illustration of one illustrative embodiment of a User Interface (UI) 130 for in-vehicle navigation of the present disclosure highlighting a driving route 133 to a driving destination 131. FIG. 3 is a schematic illustration of the UI 130 of FIG. 2 highlighting nearby amenities 135 to the driving destination 131. FIG. 4 is a schematic illustration of the UI 130 of FIGS. 2 and 3 highlighting a list 136 of nearby amenities 135 to the driving destination. FIG. 5 is a schematic illustration of the UI of FIGS. 2-4 highlighting a pedestrian route 139 between the driving destination 131 and a selected amenity/pedestrian destination 137. FIG. 6 is a schematic illustration of the UI 130 of FIGS. 2-5 highlighting a notification 129 that data for the pedestrian directions have been sent to the mobile device. As noted above, in embodiments, a multi-modal route is planned on the in-vehicle navigation system 145, such as on a display 143 thereof. Referring to FIGS. 2-6, the UI 130 is configured to receive an input for a driving destination 131 and to provide a driving route 133 from a current location 132 of the vehicle 140 to the driving destination 131. In some embodiments, and as can be seen in FIGS. 2 and 3, along with identifying the driving destination 131, such as by name and/or by address, the UI 130 provides a nearby amenities selector 134 which provides a user an on-screen button to select. Upon selection, as can be seen in FIG. 4, a list 136 of amenities nearby to the driving destination 131 is provided. Alternatively, in some embodiments, the list 136 is automatically provided based on which type of location is selected for the driving destination 131. For example, in some embodiments, in response to the driving destination 131 being a charging station 50, the list 136 is automatically provided in the UI 130. Further, in some embodiments, as can be seen in FIGS. 3 and 4, nearby amenities 135 are illustrated on the map in the UI 130 while the map is zoomed in to a predetermined level of detail.

As can be seen in FIG. 5, upon selection of one of the nearby amenities 135, either from the list 136 or from the map, the nearby amenity selected/pedestrian destination 137 is displayed in the UI 130 including a pedestrian route 139 from the driving destination 131 to the selected amenity/pedestrian destination 139. In embodiments, the UI 130 also displays destination details 138 of the pedestrian destination 137. As can be seen in FIG. 5, in some embodiments, the pedestrian route 139 is displayed differently than that of the driving route 133, such as a different line type (as shown in FIG. 5), a different line weight, a different color, and the like.

Data for the pedestrian route 139 is provided to the mobile device 150 for providing the turn-by-turn navigation for the pedestrian route 139 thereon. The data includes any of the pedestrian destination 137, the driving destination 131, turn-by-turn navigation therebetween, any combination thereof, and the like.

In some embodiments, the data for the pedestrian route 139 is sent from the in-vehicle navigation system 145 based on a selection of an on-screen button 128. As can be seen in FIGS. 4 and 5, the on-screen button 128 can be an icon of a mobile device, an indication to send to the phone, and the like. In other embodiments, the data for the pedestrian route 139 is automatically sent to the mobile device 150. In these embodiments, the automatic sending of the pedestrian route 139 to the mobile device 150 is triggered when a predetermined condition is met, such as the vehicle arriving at the driving destination 131, the vehicle 140 being within a predetermined distance of the driving destination 131, the vehicle being turned off, and the like. In embodiments, geofencing is used to determine that the vehicle 140 is at the driving destination 131 or within a predetermined distance thereof.

In embodiments, once the data for the pedestrian route 139 is sent to the mobile device 130, a notification 129 is displayed on the UI 130. As noted above, the data can be sent directly, such as via short-range radio communication or other wireless communication protocols, or indirectly, such as via a cloud system 100 associated with the vehicle 140/in-vehicle navigation system 145.

FIG. 7 is a schematic illustration of the illustrative embodiment of FIGS. 2-6 illustrating a lock screen 168 of a mobile device 150 of the present disclosure. FIG. 8 is a schematic illustration of illustrative embodiment of FIGS. 2-7 illustrating a UI 170 for navigation on a mobile device 150 of the present disclosure highlighting the pedestrian destination 137/pedestrian route 139 received from the vehicle 140. Referring to FIGS. 7 and 8, in embodiments, upon receipt of the data for the pedestrian route 139, the mobile device displays a notification 169 on the lock screen 168 thereof. The notification 169 being configured, upon selection thereof, to open the navigation application with the pedestrian destination 137 and/or the pedestrian route 139 thereon.

In embodiments, the notification is provided via an application running on the mobile device 150, which receives the data for the pedestrian route 139 and causes the notification 169 to appear on the lock screen 168. In some embodiments, the application is the navigation application running on the mobile device 150. In other embodiments, the application is a vehicle control application that is associated with the vehicle 140/the in-vehicle navigation system 145, which receives the data pushed thereto, such as via the cloud system 100. In some embodiments, the vehicle control application provides the turn-by-turn navigation for the pedestrian route 139 therein, and in other embodiments, the vehicle control application sends the data to a separate navigation application, which then provides the turn-by-turn navigation for the pedestrian route 139.

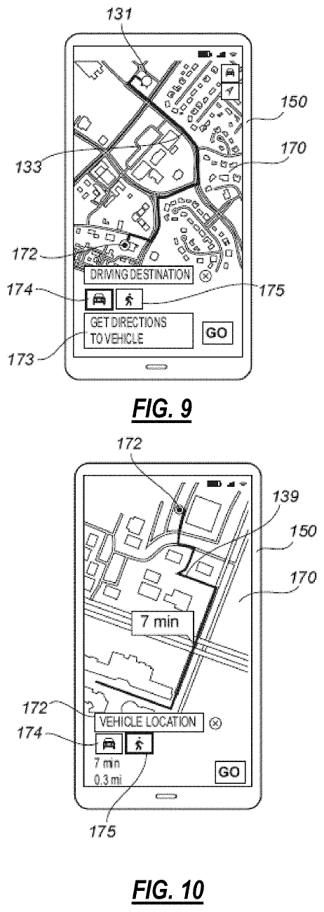

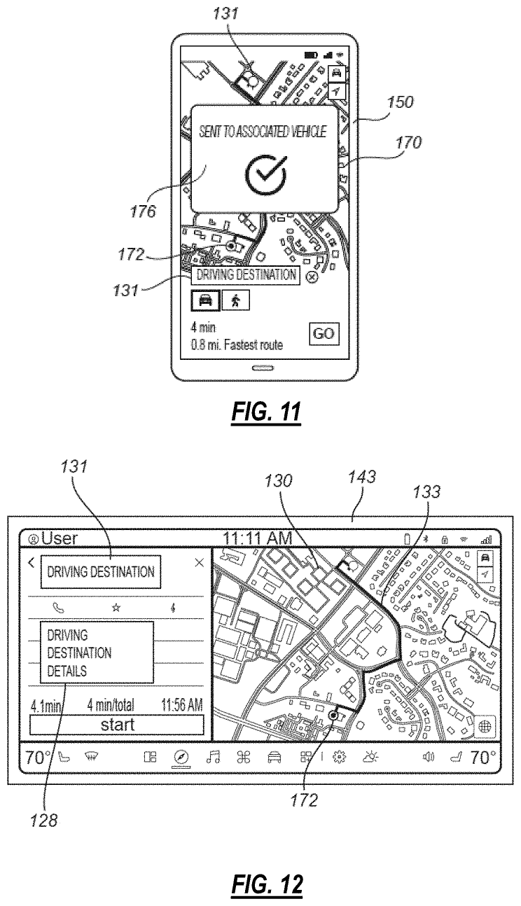

FIG. 9 is a schematic illustration of another illustrative embodiment of a UI 170 for multi-modal navigation on a mobile device 150 of the present disclosure highlighting a driving route to a driving destination. FIG. 10 is a schematic illustration of the UI of FIG. 9 highlighting a pedestrian route to an associated vehicle. FIG. 11 is a schematic illustration of the UI of FIGS. 9 and 10 highlighting a notification that the driving directions have been sent to the associated vehicle. Referring to FIGS. 9-11, in embodiments, the UI 170 is configured to receive an input for a driving destination 131 and to provide a driving route 133 thereto. In embodiments, in response to a request for driving directions, such as by a selection of a driving icon 174 (which in embodiments is selected by default), a driving route 133 from a current location 172 of the vehicle 140 and the driving destination 131 are provided and data for the driving route 133 is sent to the vehicle 140. The data for the driving route 133 includes any of the driving destination 131, the current location 172 of the vehicle 140, the turn-by-turn navigation of the driving route 133, and the like. In some embodiments, the sending of the data for the driving route 133 to the vehicle 140 is triggered by the mobile device 150 being within a predetermined range of the vehicle 140. The predetermined range can be determined based on the mobile device 150 being within a geofenced area relative to a location of the vehicle 140 or whether the mobile device 150 currently has a short-range radio communication connection currently established with the vehicle 140/the in-vehicle navigation system 145, and the like. As can be seen in FIG. 11, in embodiments, once the data for the driving route 133 is sent to the vehicle, a notification 176 is displayed on the UI 170. As noted above, the data can be sent directly, such as via short-range radio communication or other wireless communication protocols, or indirectly, such as via a cloud system 100 associated with the vehicle 140/in-vehicle navigation system 145.

Further, in some of these embodiments, a determination is made whether the mobile device 150 is within the predetermined range of the vehicle 140. In response to the mobile device 150 not being within the predetermined range of the vehicle 140, pedestrian directions 171 to the current location 172 of the vehicle 140 are provided. Further, in embodiments, as illustrated in FIG. 9, a button 173 within the UI 170 is displayed that allows for a user to select and request the pedestrian directions 171 to the vehicle 140.

In embodiments, nearby amenities to the driving destination 131 are provided in the UI 170 in a similar manner as to the nearby amenities 135 are provided in UI 130. In these embodiments, the pedestrian directions 171 to the selected nearby amenity is kept for use on the mobile device 150 while the data for the driving directions is provided to the vehicle 140. As such, in embodiments, the multi-modal navigation includes a pedestrian route 171 to the vehicle 140, a driving route 133 to a driving destination 131, and a pedestrian route 139 to a nearby amenity/pedestrian destination 137, which can be initiated on either of the in-vehicle navigation system 145 and the mobile device 150.

FIG. 12 is a schematic illustration of illustrative embodiment of FIGS. 9-11 illustrating a UI 130 for in-vehicle navigation of the present disclosure highlighting a driving route 133 to the driving destination 131 received from the mobile device 150. In embodiments, upon receipt of the data for the driving route 133, the vehicle 140/in-vehicle navigation system 145 provides the driving route 133 between the current location 172 of the vehicle 140 and the driving destination 131, such as turn-by-turn navigation to the driving destination 131.

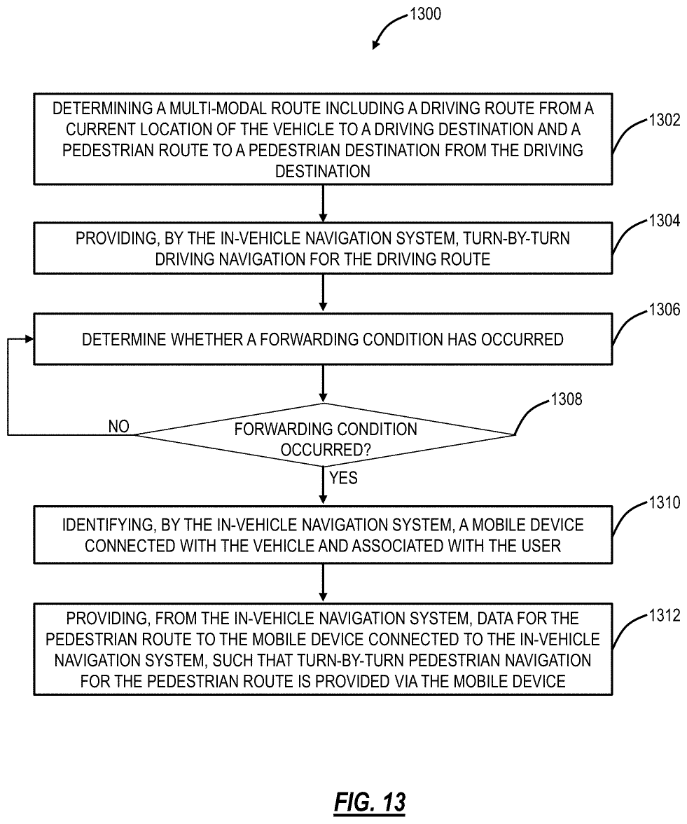

FIG. 13 is a flowchart of one illustrative embodiment of a method 1300 for multi-modal route planning of the present disclosure. Upon receiving a destination input via an in-vehicle navigation system or a mobile device, the method 1300 includes determining a multi-modal route including a driving route from a current location of the vehicle to a driving destination and a pedestrian route to a pedestrian destination from the driving destination at step 1302. In some embodiments, the destination input is provided by a user, pushed from an application of the in-vehicle navigation system or the mobile device, and the like. In some embodiments, the driving route and the pedestrian route are determined/generated by the in-vehicle navigation system of the vehicle and locally stored mapping information for determining the driving route based on the driving destination and a current location of the vehicle and determining the pedestrian route based on the driving destination and the pedestrian destination. In other embodiments, the driving route and the pedestrian route are determined/generated by a cloud system, such as a network-connected server thereof, associated with the in-vehicle navigation system/vehicle and then provided to/obtained by the in-vehicle navigation system. In other embodiments, the routes are determined/generated by a combination of the in-vehicle navigation system and the cloud system.

The method also includes providing turn-by-turn driving navigation for the driving route at step 1304. In embodiments, the turn-by-turn driving navigation is provided by the in-vehicle navigation system. The method 1300 further includes determining whether a forwarding condition has occurred at step 1306. Upon determining that a forwarding condition has occurred, in step 1308, the method includes identifying, by the in-vehicle navigation system, a mobile device connected with the vehicle and associated with the user in step 1310. In step 1312, the method further includes providing, from the in-vehicle navigation system, data for the pedestrian route to the mobile device connected to the in-vehicle navigation system, such that turn-by-turn pedestrian navigation for the pedestrian route is provided via the mobile device. In embodiments, the mobile device is connected to the in-vehicle navigation system/vehicle via a connection chosen from a wired connection, a wireless communication protocol, such as a short-range wireless protocol (e.g. Bluetooth Low Energy (BLE)), and the like.

In some embodiments, on the forwarding condition includes at least one condition chosen from receiving a selection for a user to send the data for the pedestrian route to the mobile device, a determination that the vehicle has arrived at the driving destination (such as based on Global Positioning System (GPS) coordinates of the current vehicle location, geofencing, and the like), the vehicle being within a predetermined distance of the driving destination (such as based on GPS coordinates of the current vehicle location, geofencing, determining that the mobile device/user has exceeded a predetermined distance threshold from the vehicle, and the like). In some of these embodiments, the determination that the mobile device/user has exceeded a predetermined distance threshold from the vehicle is based on the mobile device exceeding the range of a first wireless communication protocol (such as Near Field Communication (NFC) while the mobile device remains paired with the in-vehicle navigation system/vehicle via a second wireless protocol (such as a short-range wireless protocol).

In some embodiments, providing the data for the pedestrian route to the mobile device is performed by pushing the data by a technique chosen from directly via short-range radio communication and indirectly via a cloud system associated with the in-vehicle navigation system. In some of these embodiments, the data is pushed to a vehicle control application associated with the vehicle and running on the mobile device, and the method 1300 includes the vehicle control application performing a process chosen from providing the turn-by-turn pedestrian navigation for the pedestrian route and providing the data to a navigation application running on the mobile device.

In embodiments, the method 1300 further includes upon receipt of a driving destination in a user interface, displaying one or more nearby amenities in the user interface for selection thereof, and based on the selection, obtaining the pedestrian route, the pedestrian destination being a nearby amenity selected. In some of these embodiments, wherein the one or more nearby amenities is automatically displayed on the user interface upon receipt of the driving destination in response to the driving destination being a predetermined type of destination.

In embodiments, the data for the pedestrian route includes at least one type of data chosen from pedestrian destination data, driving destination data, and turn-by-turn pedestrian navigation data.

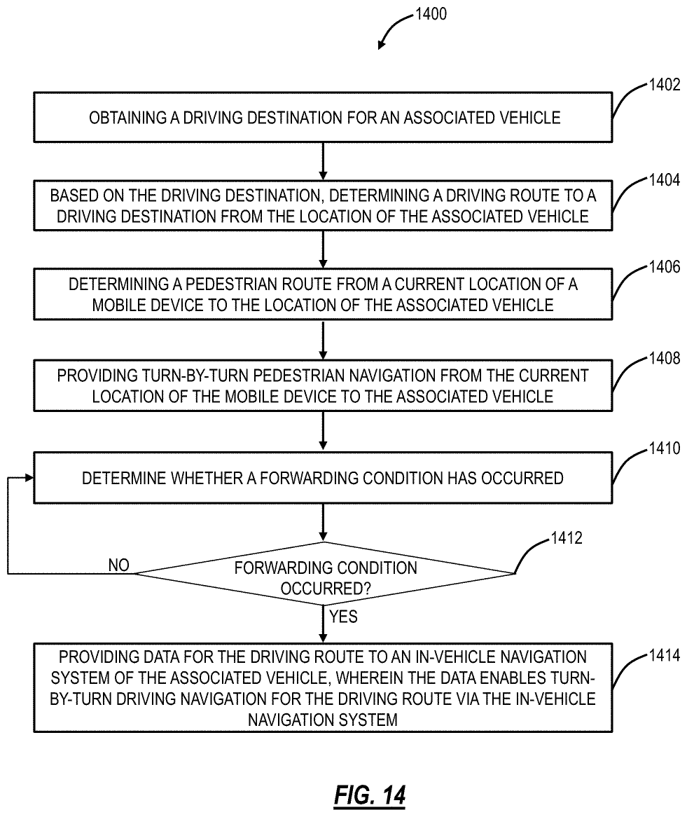

FIG. 14 is a flowchart of another illustrative embodiment of a method 1400 for multi-modal route planning of the present disclosure. The method 1400 includes obtaining a driving destination for an associated vehicle at step 1402. In embodiments, the driving destination is obtained via the mobile device (such as via a navigation application, an application associated with the vehicle, and the like). In some embodiments, the driving destination is also provided/pushed to a cloud system, such as a network-connected server thereof, associated with the vehicle/an in-vehicle navigation system of the vehicle.

In step 1404, based on the driving destination, determining a driving route to a driving destination from the location of the associated vehicle. In one embodiment, the driving route is determined/generated by the mobile device, such as via a navigation application, and determined based on the current location of the vehicle and the driving destination. In these embodiments, the location of the vehicle is obtained by a previously stored location of the vehicle (such as by marking where the mobile device disconnected from the vehicle) or by a query of the vehicle location via the cloud system, such as the network-connected server thereof, associated with the vehicle. In other embodiments, the driving route is determined/generated by the cloud system, such as the network-connected server thereof, associated with the vehicle upon receipt of the driving destination from the mobile device. In these embodiments, the cloud system obtains the vehicle location from the vehicle prior to determining/generating the driving route.

The method 1400 also includes determining a pedestrian route from a current location of a mobile device to the location of the associated vehicle at step 1406. In embodiments, the pedestrian route is determined/generated by the mobile device determining the pedestrian route based on the vehicle location and the current location of the mobile device. In other embodiments, the pedestrian route is determined/generated by and obtained from the cloud system, such as the network-connected server thereof, associated with the vehicle.

The method 1400 further includes providing turn-by-turn pedestrian navigation from the current location of the mobile device to the associated vehicle at step 1408. The method further includes determining whether a forwarding condition has occurred at step 1410. Upon determining that a forwarding condition has occurred in step 1412, the method 1400 yet further includes providing data for the driving route to an in-vehicle navigation system of the associated vehicle, wherein the data enables turn-by-turn driving navigation for the driving route via the in-vehicle navigation system at step 1414.

In embodiments, the forwarding condition includes at least one condition chosen from detecting that the user is within a predetermined distance of the vehicle, such as via GPS/geofencing, detecting that the user is within a communication threshold of the vehicle, such as by the mobile device connecting to the in-vehicle navigation system, receiving a selection of the driving destination at the cloud system, and the like. In some embodiments, the data is provided to the in-vehicle navigation system via one entity chosen from the mobile device and the cloud system, such as the network-connected server thereof, associated with the vehicle. In some embodiments, receipt of the data from the mobile device is via direct communication between the mobile device and the in-vehicle navigation system. In other embodiments, receipt of the data from the mobile device is via indirect communication via the cloud system. In other embodiments, such as in embodiments where the cloud system determines the driving route, the data is sent from the cloud system to the in-vehicle navigation system. In some embodiments, the data for the driving route is provided to the in-vehicle navigation system by pushing the data by a technique chosen from directly from the mobile device via short-range radio communication and indirectly via a cloud system associated with the in-vehicle navigation system.

In embodiments, the method 1400 still further includes obtaining a second pedestrian route from the driving destination to a pedestrian destination and initiating the second pedestrian route on the mobile device upon arrival at the driving destination. In some of these embodiments, the pedestrian destination is a nearby amenity selected by a user, in any manner described above, such as the nearby amenity selected with respect to the method 1300.

In some embodiments, the obtaining of the pedestrian route from the current location of the mobile device is initiated automatically based on a determination that the mobile device is in a different location than the associated vehicle.

In some embodiments, the determination that the mobile device is in a different location than the associated vehicle is based on the mobile device being a predetermined distance from the associated vehicle. In embodiments, the predetermined distance is established based on a visibility of the associated vehicle relative to a position of the mobile device, a set distance, a type of location that the associated vehicle is positioned in (such as a parking lot), and the like.

In some embodiments, the data for the pedestrian route includes at least one type of data chosen from driving destination data and turn-by-turn driving navigation data.

In other embodiments, various combinations of the embodiments of the methods 1300 and 1400 described are also performed together, simultaneously, or sequentially.

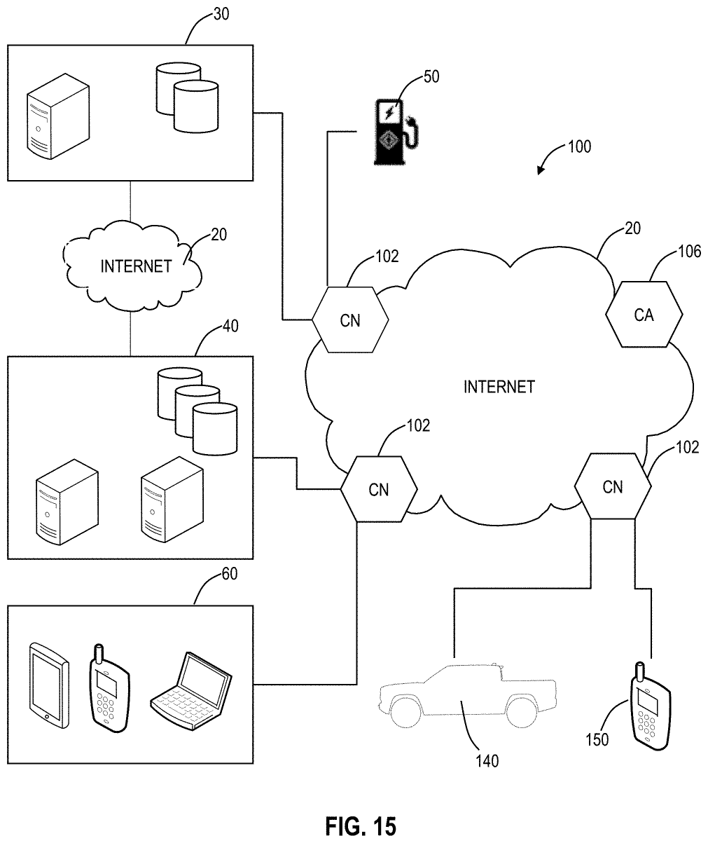

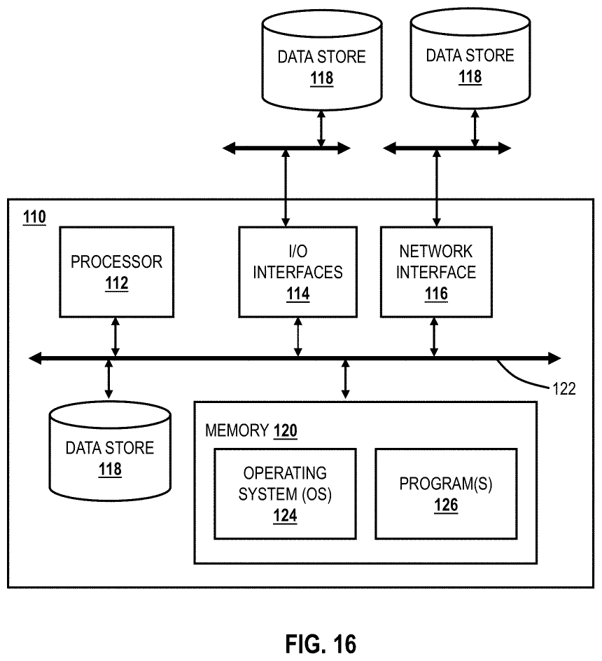

FIG. 15 is a network diagram of the cloud system 100 for implementing various cloud-based services of the present disclosure, where applicable. The cloud system 100 includes one or more cloud nodes (CNs) 102 communicatively coupled to the Internet 104 or the like. In embodiments, the cloud nodes 102 are implemented as a server or other processing system 110 (as illustrated in FIG. 16) or the like and are geographically diverse from one another, such as located at various data centers around the country or globe. In some embodiments, the cloud nodes are network-connected servers associated with the vehicle 140. Further, in some embodiments, the cloud system 100 includes one or more central authority (CA) nodes 106, which similarly are implemented as the server 110 and are connected to the CNs 102. For illustration purposes, the cloud system 100 connects to data sources 30, a data aggregation system 40, charging stations 50, various individual's homes 60, vehicles 140, and mobile devices 150, each of which communicatively couples to one of the CNs 102. These locations 30, 40, and 60 and devices 140 and 150 are shown for illustrative purposes, and those skilled in the art will recognize there are various access scenarios to the cloud system 100, all of which are contemplated herein. The cloud system 100 can be a private cloud, a public cloud, a combination of a private cloud and a public cloud (hybrid cloud), or the like.

Again, the cloud system 100 provides any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the charging stations 50, the devices an individual's home 60, the vehicles 140, and the mobile devices 150.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” is sometimes used to describe application programs offered through cloud computing. A common shorthand for a provided cloud computing service (or even an aggregation of all existing cloud services) is “the cloud.” The cloud system 100 is illustrated herein as one example embodiment of a cloud-based system, and those of ordinary skill in the art will recognize the systems and methods described herein are not necessarily limited thereby.

FIG. 16 is a block diagram of a server or other processing system 110, which may be used in the cloud system 100 (FIG. 15), in other systems, or stand-alone, such as in the vehicle itself. For example, the CNs 102 (FIG. 15) and the central authority nodes 106 (FIG. 15) may be formed as one or more of the servers 110. In embodiments, the server 110 is a digital computer that, in terms of hardware architecture, generally includes a processor 112, input/output (I/O) interfaces 114, a network interface 116, a data store 118, and memory 120. It should be appreciated by those of ordinary skill in the art that FIG. 16 depicts the server or other processing system 110 in an oversimplified manner, and a practical embodiment may include additional components and suitably configured processing logic to support known or conventional operating features that are not described in detail herein. The components (112, 114, 116, 118, and 120) are communicatively coupled via a local interface 122. The local interface 122 may be, for example, but is not limited to, one or more buses or other wired or wireless connections, as is known in the art. The local interface 122 may have additional elements, which are omitted for simplicity, such as controllers, buffers (caches), drivers, repeaters, and receivers, among many others, to enable communications. Further, the local interface 122 may include address, control, and/or data connections to enable appropriate communications among the aforementioned components.

The processor 112 is a hardware device for executing software instructions. The processor 112 may be any custom made or commercially available processor, a central processing unit (CPU), an auxiliary processor among several processors associated with the server 110, a semiconductor-based microprocessor (in the form of a microchip or chipset), or generally any device for executing software instructions. When the server 110 is in operation, the processor 112 is configured to execute software stored within the memory 120, to communicate data to and from the memory 120, and to generally control operations of the server 110 pursuant to the software instructions. The I/O interfaces 114 may be used to receive user input from and/or for providing system output to one or more devices or components.

The network interface 116 may be used to enable the server 110 to communicate on a network, such as the Internet 114 (FIG. 15). The network interface 116 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 116 may include address, control, and/or data connections to enable appropriate communications on the network. A data store 118 may be used to store data. The data store 118 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 118 may incorporate electronic, magnetic, optical, and/or other types of storage media. In one example, the data store 118 may be located internal to the server 110, such as, for example, an internal hard drive connected to the local interface 122 in the server 110. Additionally, in another embodiment, the data store 118 may be located external to the server 110 such as, for example, an external hard drive connected to the I/O interfaces 114 (e.g., a SCSI or USB connection). In a further embodiment, the data store 118 may be connected to the server 110 through a network, such as, for example, a network-attached file server.

In embodiments, the memory 120 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 120 may incorporate electronic, magnetic, optical, and/or other types of storage media. Note that the memory 120 may have a distributed architecture, where various components are situated remotely from one another but can be accessed by the processor 112. The software in memory 120 may include one or more software programs, each of which includes an ordered listing of executable instructions for implementing logical functions. The software in the memory 120 includes a suitable operating system (O/S) 124 and one or more programs 126. The operating system 124 essentially controls the execution of other computer programs, such as the one or more programs 126, and provides scheduling, input-output control, file and data management, memory management, and communication control and related services. The one or more programs 126 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

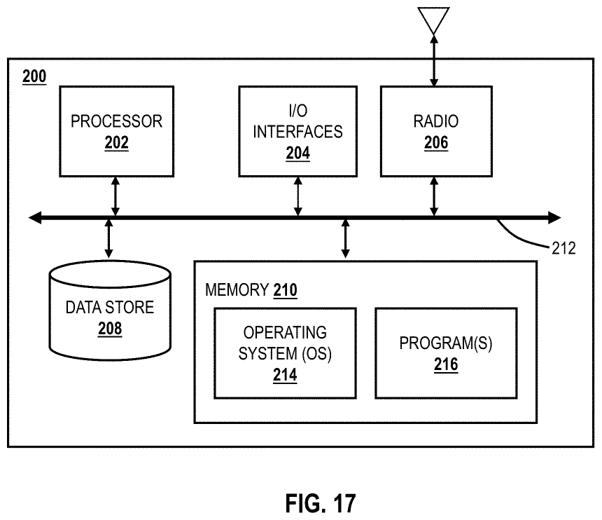

FIG. 17 is a block diagram of a computing device 200, which may be used in the cloud system 100 (FIG. 15), as part of a network, or stand-alone. In embodiments, the computing device 200 is one of the in-vehicle navigation system 145 and the mobile device 150. In embodiments, the in-vehicle navigation system 145 is or is part of any control system, infotainment system, and the like of the vehicle 140. In embodiments, the mobile device 150 is one of a smartphone, a tablet, a smartwatch, a laptop, etc.

The computing device 200 can be a digital device that, in terms of hardware architecture, generally includes a processor 202, I/O interfaces 204, a radio 206, a data store 208, and memory 210. It should be appreciated by those of ordinary skill in the art that FIG. 17 depicts the computing device 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 can be, for example, but is not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. In embodiments, the processor 202 is any custom made or commercially available processor, a CPU, an auxiliary processor among several processors associated with the computing device 200, a semiconductor-based microprocessor (in the form of a microchip or chipset), or generally any device for executing software instructions. When the computing device 200 is in operation, the processor 202 is configured to execute software stored within the memory 210, to communicate data to and from the memory 210, and to generally control operations of the computing device 200 pursuant to the software instructions. In an embodiment, the processor 202 may include a mobile optimized processor such as optimized for power consumption and mobile applications. In embodiments, the I/O interfaces 204 are used to receive user input from and/or for providing system output and includes a touch screen display. User input can be provided via, for example, a user interface on a touch screen display (such as UI 130 or UI 170), a keypad, a scroll ball, a scroll bar, buttons, and the like. System output can be provided via a display device such as a liquid crystal display (LCD), touch screen, and the like.

The radio 206 enables wireless communication to an external access device or network. Any number of suitable wireless data communication protocols, techniques, or methodologies can be supported by the radio 206, including any protocols for wireless communication. The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media.

Again, in embodiments, the memory 210 includes any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 can include one or more software programs, each of which includes an ordered listing of executable instructions for implementing logical functions. In the example of FIG. 17, the software in the memory 210 includes a suitable operating system 214 and programs 216. The operating system 214 essentially controls the execution of other computer programs and provides scheduling, input-output control, file and data management, memory management, and communication control and related services. The programs 216 may include various applications, add-ons, etc. configured to provide end user functionality with the computing device 200. For example, example programs 216 may include, but not limited to, a web browser, social networking applications, streaming media applications, games, mapping and location applications, electronic mail applications, financial applications, and the like. In a typical example, the end-user typically uses one or more of the programs 216 along with a network, such as the cloud system 100 (FIG. 15).

Although the present disclosure is illustrated and described with reference to illustrative embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A navigation system for a vehicle, comprising:
one or more processors and a memory storing computer-executable instructions that, when executed, cause the one or more processors to:
receive a destination input for the vehicle;
based on the destination input, determine a multi-modal route including a driving route to a driving destination from a current location of the vehicle and a pedestrian route to a pedestrian destination from the driving destination;
provide turn-by-turn driving navigation instructions for the driving route; and
provide data for the pedestrian route to a mobile device associated with the user, wherein the data enables turn-by-turn pedestrian navigation instructions for the pedestrian route via the mobile device.

2. The in-vehicle navigation system of claim 1, wherein the instructions that, when executed, causing the one or more processors to provide the data for the pedestrian route to the mobile device is initiated based on a forwarding condition including at least one condition chosen from receiving a selection for a user to send the data for the pedestrian route to the mobile device, arrival of the vehicle at the driving destination, determining that the user and mobile device has exceeded a predetermined distance threshold from the vehicle, and the vehicle being within a predetermined distance of the driving destination.

3. The in-vehicle navigation system of claim 1, wherein the instructions that, when executed, causing the one or more processors to provide the data for the pedestrian route to the mobile device is performed by pushing the data by a technique chosen from directly via short-range radio communication and indirectly via a cloud system associated with the in-vehicle navigation system.

4. The in-vehicle navigation system of claim 3, wherein the data is pushed to a vehicle control application associated with the vehicle and running on the mobile device, and wherein the vehicle control application is configured to perform a process chosen from providing the turn-by-turn pedestrian navigation for the pedestrian route and providing the data to a navigation application running on the mobile device.

5. The in-vehicle navigation system of claim 1, wherein the instructions that, when executed, cause the one or more processors to, upon receipt of the driving destination in a user interface, display one or more nearby amenities in the user interface for selection thereof, and based on the selection, determine the pedestrian route, the pedestrian destination being a nearby amenity selected.

6. The in-vehicle navigation system of claim 5, wherein the one or more nearby amenities is automatically displayed on the user interface upon receipt of the driving destination in response to the driving destination being a predetermined type of destination.

7. The in-vehicle navigation system of claim 1, wherein the data for the pedestrian route includes at least one type of data chosen from pedestrian destination data, driving destination data, and turn-by-turn pedestrian navigation data.

8. A method for multi-modal navigation, comprising:
receiving, at an in-vehicle navigation system of a vehicle, a destination input for the vehicle;
based on the desired destination, determining, by an in-vehicle navigation system of a vehicle, a multi-modal route including a driving route to the driving destination from a current location of the vehicle and a pedestrian route to a pedestrian destination from the driving destination;
providing, by the in-vehicle navigation system, turn-by-turn driving navigation for the driving route; and
providing data for the pedestrian route to a mobile device associated with the user, wherein the data enables turn-by-turn pedestrian navigation for the pedestrian route via the mobile device.

9. The method of claim 8, wherein providing the data for the pedestrian route to the mobile device is initiated based on at least one condition chosen from receiving a selection for a user to send the data for the pedestrian route to the mobile device, arrival of the vehicle at the driving destination, determining that the user and mobile device has exceeded a predetermined distance threshold from the vehicle, and the vehicle being within a predetermined distance of the driving destination.

10. The method of claim 8, wherein the data for the pedestrian route is provided to a vehicle control application associated with the vehicle and running on the mobile device, and wherein the method includes the vehicle control application performing a process chosen from providing the turn-by-turn pedestrian navigation for the pedestrian route and providing the data to a navigation application running on the mobile device.

11. The method of claim 8, further comprising:
upon receipt of the driving destination in a user interface, displaying one or more nearby amenities in the user interface for selection thereof; and
based on the selection, obtaining the pedestrian route, the pedestrian destination being a nearby amenity selected.

12. The method of claim 11, wherein the one or more nearby amenities is automatically displayed on the user interface upon receipt of the driving destination in response to the driving destination being a predetermined type of destination.

13. The method of claim 8, wherein the data for the pedestrian route includes at least one type of data chosen from pedestrian destination data, driving destination data, and turn-by-turn pedestrian navigation data.

14. The method of claim 8, further comprising:
obtaining a second driving destination for the vehicle;
based on the second driving destination, determining a second driving route to a second driving destination from a current location of the vehicle;
based on the location of the vehicle and a current location of the mobile device, determining a second pedestrian route from the current location of the mobile device to the current location of the vehicle;
providing a second turn-by-turn pedestrian navigation from the current location of the mobile device to the vehicle via the mobile device; and
providing data for the second driving route to an the-vehicle navigation system, wherein the data enables second turn-by-turn driving navigation for the second driving route via the in-vehicle navigation system.

15. A method for multi-modal navigation, comprising:
obtaining a driving destination for an associated vehicle;
based on the driving destination, determining a driving route to the driving destination from a location of the associated vehicle;
based on the location of the associated vehicle and a current location of a mobile device associated with the user, determining a pedestrian route from the current location of the mobile device to the location of the associated vehicle;
providing turn-by-turn pedestrian navigation from the current location of the mobile device to the associated vehicle via the mobile device; and
providing data for the driving route to an in-vehicle navigation system of the associated vehicle, wherein the data enables turn-by-turn driving navigation for the driving route via the in-vehicle navigation system.

16. The method of claim 15, further comprising:
obtaining a second pedestrian route from the driving destination to a pedestrian destination; and
initiating the second pedestrian route on the mobile device upon arrival at the driving destination.

17. The method of claim 15, wherein the determining of the pedestrian route from the current location of the mobile device to the location of the associated vehicle is initiated automatically based on a determination that the mobile device is in a different location than the associated vehicle.

18. The method of claim 17, wherein the determination that the mobile device is in a different location than the associated vehicle is based on the mobile device being a predetermined distance from the associated vehicle.

19. The method of claim 15, wherein the data for the driving route is provided to the in-vehicle navigation system by pushing the data by a technique chosen from directly from the mobile device via short-range radio communication and indirectly via a cloud system associated with the in-vehicle navigation system.

20. The method of claim 15, wherein the data for the pedestrian route includes at least one type of data chosen from driving destination data and turn-by-turn driving navigation data.
